(19) United States
(12) Patent Application Publication
(10) Pub. No.: US 2014/0308419 A1
(43) Pub. Date: Oct. 16, 2014

(54) System and Method for Cooking Seafood Products

(71) Applicants: Thailand Research Fund, Bangkok (TH); Food Machinery Co., Ltd., Songkhla (TH); King Mongkut's Institute of Technology Ladkrabang, Bangkok (TH)

(72) Inventors: Pimpen Pornchaloempong, Bangkok (TH); Panmanas Sirisomboon, Bangkok (TH); Navaphattra Nunak, Bangkok (TH); Maturada Jinoros, Bangkok (TH); Kittisak Witinantakit, Chonburi (TH)

(73) Assignees: Thailand Research Fund, Bangkok (TH); Food Machinery Co., Ltd., Songkhla (TH); King Mongkut's Institute of Technology Ladkrabang, Bangkok (TH)

(21) Appl. No.: 13/999,536

(22) Filed: Mar. 7, 2014

Related U.S. Application Data
(63) Continuation of application No. PCT/TH2011/000042, filed on Sep. 9, 2011.

(51) Int. Cl. A47J 27/04; A23L 1/325

(52) U.S. Cl. CPC A47J 27/04; A23L 1/325; A47J 2027/043
USPC 426/510; 99/326

(57) ABSTRACT

A seafood product cooking system includes a cooking vessel; a sensing module; a control module for measuring a set of cooking vessel parameters and outputting a set of control signals; a processing module for processing at least one signal from the sensing module and issuing control commands to the control module; and a memory module configurable to store a set of cooking process program instructions. A cooking process includes loading the product inside the cooking vessel; creating a negative pressure therein; increasing cooking vessel temperature to a first temperature; pumping in vapour comprising water vapour into the cooking vessel to initiate a process of attaining a second temperature lesser than the first temperature, wherein attaining the second temperature includes dwelling the seafood product at a plurality of intermediate temperatures; and spraying fluid including water on the seafood product to attain a third temperature that is lesser than the second temperature.

### CROSS-REFERENCE TO RELATED APPLICATIONS

This application is a continuation of International Application Number PCT/TH2011/000042, with an international filing date of 9 Sep. 2011, which was published in English under PCT Article 21(2) as International Publication Number WO 2013/036209, and which is incorporated by reference herein in its entirety.

### TECHNICAL FIELD

The present disclosure relates generally to systems and methods for processing seafood. More particularly, the present disclosure is directed to systems and methods for processing or cooking seafood by way of subjecting the seafood to different temperatures and different negative or vacuum pressures in association with a seafood processing technique or cycle that includes a cooking phase and a cooling phase.

### BACKGROUND

The fishing industry is usually accompanied by the processing of seafood under controlled conditions. This is because seafood has to be transported to far flung places and has to be properly preserved. Preservation ranges from simply adding salt to heating the seafood. Processing by heating also provides the advantage of cooking the seafood so that it can be readily eaten or prepared with little or no additional cooking. An existing system for cooking seafood is described in U.S. Pat. No. 6,153,860, entitled “System, Controller, Computer Readable Memory, and Method for Precise On-Line Control of Heat Transfer in a Food Preparation Process.”

Usually, seafood processing involves subjecting the seafood to cooking at a constant high temperature for an extended or long period time. Unfortunately, subjecting the seafood to temperatures higher than 80° C. for an extended period of time leads to substantial seafood moisture loss and weight loss. Increased moisture loss results in the flesh becoming stiff and hard, adversely affecting flesh texture and/or taste, which is not appreciated by many a palate. Consequently, cooking a seafood product in such a manner can have an undesirable impact upon the seafood product's commercial viability or success. Less moisture in the flesh is also evidenced by the colour of the cooked seafood flesh becoming bright red. Properly cooked seafood flesh is light in colour, rather than an intense colour.

Constant cooking or steaming at high temperatures also consumes a lot of energy in maintaining the temperature in the cooking chamber.

In light of the above, improved systems and techniques are required for proper cooking of the seafood so as to ameliorate the above problems.

### SUMMARY

Aspects of the disclosure provide a system for cooking a seafood product.

In accordance with one aspect of the disclosure, the system for cooking a seafood product includes a cooking vessel which is configured to carry the seafood product and is configurable to receive a set of control signals. The system further includes a sensing module couplable to the cooking vessel and configurable to measure a set of physical parameters of the cooking vessel and output a set of signals corresponding to the set of physical parameters. The system further includes a processing module couplable to the sensing module and configurable to execute a set of stored program instructions and process at least one signal received from the sensing module. The system further includes a control module couplable to the processing module and the cooking vessel and configurable to receive control commands from the processing module and output the set of control signals to the cooking vessel. The system further includes a memory module couplable to the processing module and configurable to store a cooking control manager comprising a set of program instructions to perform a cooking method or process. The cooking process includes the steps of loading the product inside the cooking vessel of the system, creating a negative pressure inside the cooking vessel, increasing the temperature of the cooking vessel to a first temperature, pumping in vapour (e.g., steam) comprising water vapour into the cooking vessel to initiate a process of attaining a second temperature in the seafood product, the second temperature being lesser than the first temperature, wherein the process of attaining the second temperature includes dwelling the cooking vessel at a plurality of intermediate temperatures between the first temperature and the second temperature and spraying fluid including water on the seafood product inside the cooking vessel to attain a third temperature in the seafood product, wherein the third temperature is lesser than the second temperature.

In accordance with another aspect of the disclosure, the first temperature is in the range of 100° C. to 105° C. In accordance with a further aspect of the disclosure, the first temperature is approximately 100° C. In accordance with another aspect of the disclosure, the second temperature is in the range of 62° C. to 75° C. In accordance with a further aspect of the disclosure, the second temperature is approximately 62° C. In accordance with another aspect of the disclosure, the third temperature is approximately 50° C.

In accordance with a further aspect of the disclosure, the plurality of intermediate temperatures includes 8 intermediate temperatures. In accordance with a further aspect of the disclosure, the negative pressure is approximately 0.85 bar in magnitude. In accordance with a further aspect of the disclosure, the second temperature and the third temperature are measured at a backbone of the seafood product.

In accordance with another aspect of the disclosure, a process of cooking a seafood product includes providing a cooking vessel including a seafood product, creating a negative pressure inside the cooking vessel, increasing the temperature of the cooking vessel to a first temperature, pumping in vapour (e.g., steam) comprising water vapour into the cooking vessel to initiate a process of attaining a second temperature in the seafood product, the second temperature being lesser than the first temperature, wherein the process of attaining the second temperature includes dwelling the cooking vessel at a plurality of intermediate temperatures between the first temperature and the second temperature and spraying fluid including water on the seafood product inside the cooking vessel to attain a third temperature in the seafood product, wherein the third temperature is lesser than the second temperature.

In accordance with another aspect of the disclosure, the first temperature is in the range of 100° C. to 105° C. In accordance with a further aspect of the disclosure, the first temperature is approximately 100° C. In accordance with another aspect of the disclosure, the second temperature is in the range of 62° C. to 75° C. In accordance with a further aspect of the disclosure, the second temperature is approximately 62° C. In accordance with another aspect of the disclosure, the third temperature is approximately 50° C.

In accordance with a further aspect of the disclosure, the plurality of intermediate temperatures includes 8 intermediate temperatures. In accordance with a further aspect of the disclosure, the negative pressure is approximately 0.85 bar in magnitude. In accordance with a further aspect of the disclosure, the second temperature and the third temperature are measured at a backbone of the seafood product.

### BRIEF DESCRIPTION OF DRAWINGS

FIG. 1 is a block diagram of a system for cooking a seafood product in accordance with particular embodiments of the present disclosure.

FIG. 2 is a flow diagram of a process for cooking a seafood product in accordance with particular embodiments of the present disclosure.

FIG. 3 is a graph showing the relationship between the cooking vessel temperature and the backbone temperature

### DETAILED DESCRIPTION

Embodiments of the present disclosure are directed to systems, apparatuses, devices, methods, techniques, and processes for cooking seafood products, by which at least one seafood product is subjected to a plurality of different temperature conditions and negative or vacuum pressure conditions during a seafood cooking process that includes a cooking phase and a cooling phase. A seafood product can include or be any produce from a body of water (e.g., an ocean, sea, or river), for instance, tuna or other types of fishes which are consumed by humans. The temperature and negative pressure conditions, collectively called cooking conditions, used in the process vary depending on the type of fish. The characteristics of the fish that determine the cooking conditions are the shape, size of the fish and the thermal properties of the fish. To elaborate further, the size of the fish relates to the amount of flesh to be cooked and the surface area of the fish available for cooking, which brings about a change in the cooking conditions. The shape of the fish relates to the cross-section of the fish and determines the thickness to which the heat has to propagate, penetrate or percolate to cook the fish properly. Thermal properties of the fish may refer to thermal conductivity, thermal diffusivity and specific heat of the fish. These thermal properties are a function of the moisture content and fat content of the fish. Since different types of fish have different moisture and fat content, the thermal properties of different types of fish may vary, and along with them the cooking conditions. In case of applying this to different types of fish, the cooking apparatus and the cooking process remains the same and only the cooking conditions vary.

Seafood products cooked in accordance with embodiments of the present disclosure does not result in an excessive loss of moisture and thereby does not make the flesh stiff and hard, thereby overcoming one or more disadvantages or drawbacks indicated above.

In the present disclosure, the term user corresponds to or is defined as a non-empty finite organization of elements that mathematically exhibits a cardinality of at least 1 (i.e., a set as defined herein can correspond to a singlet or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)).

In general, an element of a set can include or be a system, an apparatus, a device, a structure, an object, a signal, a function or functional process, a physical parameter, or a value depending upon the type of set under consideration.

Unless explicitly stated otherwise, in the description herein, the recitation of particular numerical values or value ranges is taken to be a recitation of particular approximate numerical values or approximate value ranges. For instance, a given numerical value or value range provided below should be interpreted or defined as an approximate numerical value or value range (e.g., a temperature of 60° C. should be interpreted as approximately or about 60° C).

### Aspects of Representative Seafood Product Cooking System Embodiments

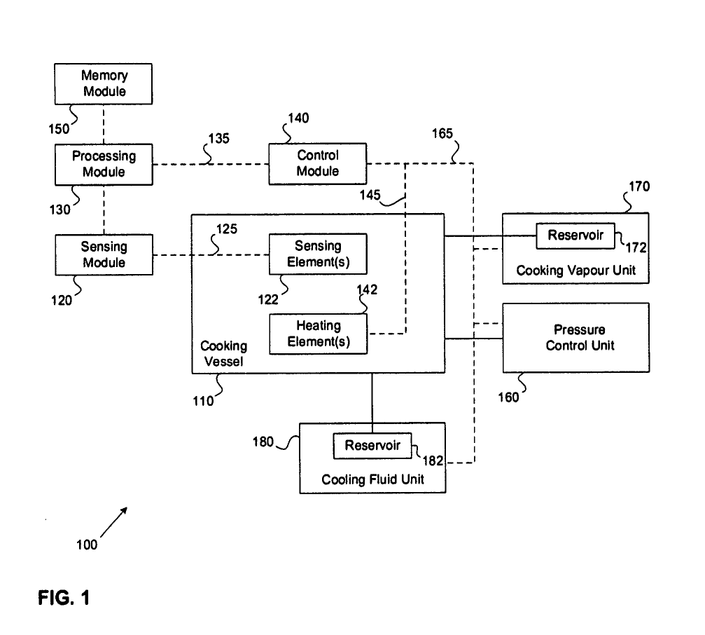

FIG. 1 is a block diagram of a system 100 for cooking a seafood product in accordance with particular embodiments of the present disclosure. As illustrated in FIG. 1, an embodiment of a system 100 for cooking a seafood product includes a cooking vessel 110; a sensing module 120; a set of sensing elements 122; a processing module 130; a cooking environment control module 140; a set of heating elements 142; a memory module 150; a pressure control unit 160 such as a vacuum pump; a cooking vapour unit 170 having a cooking vapour reservoir 172; and a cooling fluid unit 180 having a cooling fluid reservoir 182, each of which are described in detail below.

The cooking vessel 110 includes a housing, chamber, or enclosure that is configured to provide a cooking environment in which seafood products can be cooked in accordance with embodiments of the disclosure. The cooking vessel 110 can carry at least one seafood product in a suitable positioning arrangement. In various embodiments, the seafood product is heated entirely by vapour (eg. which includes steam) that is introduced into the cooking vessel 110, which involves convective heat transfer. The cooking vessel 110 is correspondingly also heated by the vapour (eg. which includes steam) that is introduced into the cooking vessel.

The cooking vessel 110 additionally carries or includes a set of sensing elements or devices 122 that is configured to sense or monitor a set of physical parameters relevant to managing or controlling a seafood cooking process according to embodiments of the disclosure. In multiple embodiments, the set of sensors 122 includes at least one pressure sensor (e.g., a vacuum pressure transducer) configured to detect or monitor a pressure within the cooking vessel 110; at least one temperature sensor (e.g., a thermocouple or infrared temperature sensor) configured to detect or monitor a cooking vessel temperature; and at least one temperature sensor configured to detect or monitor temperature at or within a portion of the body of a seafood product under consideration, such as a seafood product backbone temperature. As used herein, the term “backbone” indicates a portion of the backbone of the seafood product under consideration, at which a temperature of the seafood product is measured, monitored, or sampled during a cooking process. The backbone of the seafood product is typically the thickest part in the body of the seafood product and by virtue of the thickness it takes a long time to cook relative to other portions of the body. So if the flesh in the region of the backbone is cooked, then the flesh in the other regions will be sufficiently cooked. In other words, the backbone region is a good representative of how well the whole flesh is cooked is cooked.

The sensing module 120 includes one or more signal reception, amplification, filtering, conversion, sampling, and/or processing interfaces or devices. The sensing module 120 is electrically couplable to the set of sensing elements 122 by way of a wire-based or wireless link such as cable 115. The sensing module 120 can receive physical parameters provided by the set of sensing elements 122, and provide, generate, or output to the processing module 130 digital and/or analog cooking state indicators corresponding to sensed or received physical parameters. The sensing module 120 can include a processing element or unit (e.g., a state machine) and/or a set of signal or data storage elements (e.g., a register set or a memory).

The processing module 130 includes one or more instruction processing devices (e.g., at least one microprocessor and/or microcontroller) capable of executing stored program instructions. Additionally or alternatively, the processing module 130 can include one or more state machines. The processing module 130 is electrically couplable to the sensing module 120 by way of a wire-based or wireless link such as cable 125. The processing module 130 can process cooking state indicators received or retrieved from the sensing module 120, and output cooking control commands to the control module 140 based upon such cooking state indicators in association with the execution of stored program instructions that manage or direct aspects of a seafood product cooking process in accordance with embodiments of the disclosure.

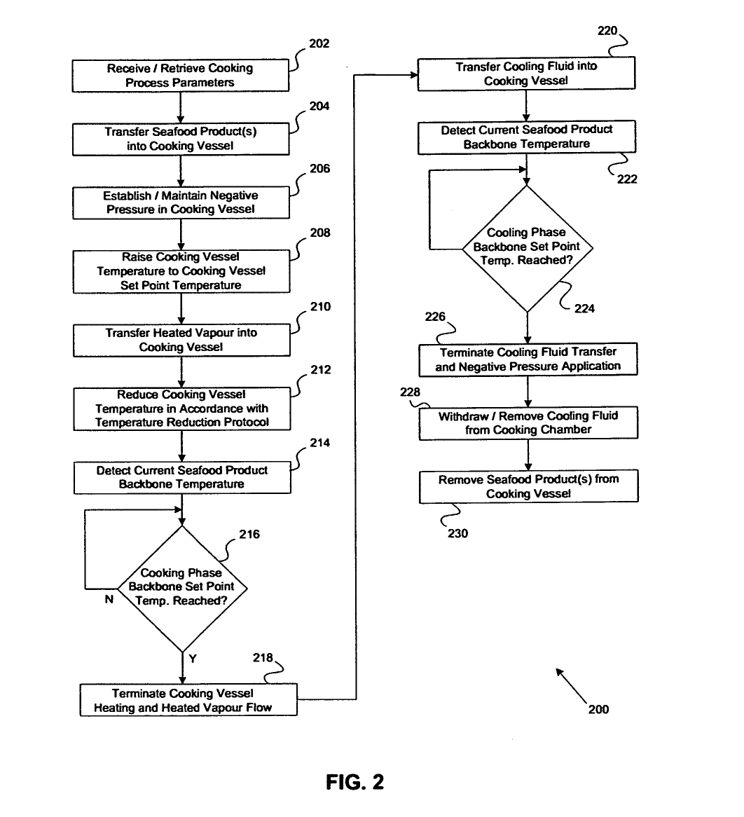

The memory module 150 includes a memory in which program instructions, parameters, and/or data reside, which facilitate or enable a seafood cooking process in accordance with various embodiments of the present disclosure. In multiple embodiments, the memory module 150 stores a set of program instructions that is executable by the processing module 155 for managing or directing aspects of a seafood cooking process described below in relation to FIG. 2. The memory module 150 can include one or more types of volatile and/or non-volatile computer or electronically readable media, such as a register set, Random Access Memory (RAM), Read Only Memory (ROM), and fixed or removable data storage devices or elements (e.g., a hard disk drive or a USB based memory device) and storage media corresponding thereto. The memory module 150 is coupled or couplable to the processing module 130 by way of one or more links or communication pathways 155.

The control module 140 includes particular interfaces, devices, or elements for selectively controlling or activating the set of heating elements 142, the pressure control unit 160, the cooking vapour unit 170, and the cooling fluid unit 180 in response to cooking control commands received from the processing module 130. Based upon such cooking control commands, the control module 140 can output heating control signals, pressure control signals, cooking vapour control signals, and cooling fluid control signals to the set of heating elements 142, the pressure control unit 160, the cooking vapour control unit 170, and the cooling fluid unit 180, respectively. The control module 140 is electrically couplable to each of the processing module 130, the set of heating elements 142, the pressure control unit 160, the cooking vapour unit 170, and the cooling fluid unit 180 by way of wire-based or wireless links, for instance, cables 135, 145, and 165.

The pressure control unit 160 includes a device such as a vacuum pump that can establish and maintain a reduced, negative, or partial vacuum pressure within the cooking vessel 110 with respect to atmospheric pressure. In several embodiments, the pressure control unit 160 can establish and maintain an internal cooking chamber pressure of approximately 0.85 bar. The pressure control unit 160 is couplable to the cooking vessel 110 by way of a passage or tube that enables fluid communication between the cooking vessel 110 and the pressure control unit 160. In some embodiments, the pressure control unit 160 includes a valve that can be selectively actuated or adjusted in response to pressure control signals received from the control module 140.

The cooking vapour unit 170 includes a heated vapour generator (e.g., a steam generator) that is couplable to the cooking vapour reservoir 172, which is couplable to the cooking vessel 110. The cooking vapour unit 170 is configurable to provide or deliver heated vapour to the cooking chamber at an intended cooking vapour temperature of approximately 100° C. The significance of this temperature will be described hereinafter.

The cooking vapour unit 170 is couplable to the cooking vessel 110 by way of a passage or tube that enables fluid communication of cooking vapour from the cooking vapour unit 170 to the cooking vessel 110. The cooking vapour unit 170 can include a valve that can be selectively actuated or adjusted in response to cooking vapour control signals received from the control module 140.

The cooling fluid unit 180 includes a cooling fluid delivery device (e.g., one or more electronically actuatable jet or spray elements) couplable to the cooling fluid reservoir 182 and the cooking vessel 110. The cooling fluid unit 180 is couplable to the cooking vessel 110 by way of a passage or tube than enables fluid communication of cooling fluid from the cooling fluid unit 180 to the cooking vessel. The cooling fluid unit 180 can include a value that can be selectively actuated or adjusted in response to cooling fluid control signals received from the control module 140.

### Aspects of Representative Seafood Cooking Process Embodiments

FIG. 2 is a flow diagram of a process 200 for cooking a seafood product in accordance with particular embodiments of the present disclosure. In an embodiment, the process 200 includes a first process portion 202 in which cooking process parameters are received and/or retrieved. Depending upon embodiment details, cooking process parameters can be input or selected by a system user (e.g., an operator of the system 100) by way of a user interface, such as an input device (e.g., a keypad or keyboard) and a visual interface (e.g., a display device or display screen) configured to receive user input. User specified and/or predetermined (e.g., most recent or default) cooking process parameters can be stored in the memory module 150.

In various embodiments, cooking process parameters can include a cooking vessel set point temperature; a fish backbone set point temperature corresponding to a cooking phase (or cooking phase backbone set point temperature); and a fish backbone set point temperature corresponding to a cooling phase (or cooling phase backbone set point temperature). In a representative implementation, the cooking vessel set point temperature can be approximately 100° C.; the cooking phase backbone set point temperature can be approximately 62° C.; and the cooling phase backbone set point temperature can be approximately 50° C. These temperatures provide for near optimum or expected optimum cooking of the tuna, which enhances the quality of the cooked tuna. As described earlier, for other types of fishes the cooking vessel set point temperature, the cooking phase backbone set point temperature and the cooling phase backbone set point temperature may vary.

In a second process portion 204, the seafood product is loaded into the cooking vessel 110. In various embodiments, a plurality of seafood products such as tuna or any other type of seafood product is loaded collectively into the cooking vessel 110. The seafood products are graded according to size to maintain uniformity with regards to size, shape and the thermal properties of the fish during the cooking process. For the purposes of an example, if the seafood cooking process is applied to a group of tuna, the group has to be separated into different lots of tuna according to the size of the fish and then the cooking process is applied to the different lots individually. Among fish of the same type, the only variation that majorly occurs is the difference in size. The shape and the thermal properties are approximately the same, irrespective of the size of the fish of the same type. The shape and the thermal properties majorly differ only with the type of fish. The cooking parameters can vary for different sizes of the same type of fish and for different types of fish.

In a third process portion 206, the pressure control unit 160 is turned on to achieve an intended or desired negative pressure (e.g., a programmably specified, predetermined, or user selectable negative pressure) to be established and/or maintained within the cooking vessel 110. In various embodiments, the magnitude of the negative pressure can be approximately 0.85 bar. By setting up a negative pressure in the cooking vessel, air is removed from the cooking vessel. Air, being an insulator of heat reduces the efficiency of heat transfer in the cooking vessel. So by removing air substantially from the cooking vessel, the insulation properties of cooking medium in the cooking vessel are reduced significantly. The cooking medium is described in detail hereinafter. After the intended or desired negative pressure is achieved, the pressure control unit 160 is turned off.

In a fourth process portion 208, the temperature of the cooking vessel 110 is increased towards and to or approximately to the cooking vessel set point temperature, for instance, approximately 100° C. During the fourth process portion 208, a current cooking vessel temperature is constantly or periodically measured by a temperature sensor fixed within or to the cooking vessel. In various embodiments, the temperature sensors are located in many parts of the cooking vessel to determine the temperature by mathematical processing such as averaging.

The sensing module 120 interfaces with the temperature sensor to acquire temperature signals, and provides or outputs current cooking temperature state indicators to the processing module 130. The processing module 130 compares the current cooking state temperature indicators to the cooking phase set point temperature. If the current cooking vessel temperature has reached or exceeds 100° C., the processing module 130 issues a cooking control command to the control module 140 to interrupt or stop heating of the cooking vessel 110. If the current cooking vessel temperature is less than 100° C., the processing module 130 issues a cooking control command to the control module 140 to heat the cooking vessel 110.

A fifth process portion 210 involves transferring, pumping, or releasing heated cooking vapour, which includes water vapour, from the cooking vapour reservoir 172 into the cooking vessel 110. In several embodiments, the transfer of heated cooking vapour into the cooking vessel 110 is initiated once the current cooking vessel temperature reaches approximately 100° C. In a representative implementation, the cooking vapour can be hot steam, and the cooking vapour reservoir 172 can be a steam reservoir into which steam is fed by a conventional steam generation unit. The hot steam provides a suitable environment for cooking the seafood product inside the cooking vessel.

A sixth process portion 212 involves reducing the temperature of the cooking vessel 110 in a controlled manner from the cooking vessel set point temperature (e.g., approximately to one or more temperatures lower than the cooking vessel temperature set point in accordance with a cooking vessel temperature reduction sequence, protocol, or process. For purpose of an example, the reduction of the temperature of the cooking vessel in a controlled manner can be carried out by maintaining a temperature of 90° C. for 20 minutes, a temperature of 80° C. for 15 minutes and 85° C. for 15 minutes). Usually for larger or big fishes, the number of steps is greater and for small size fishes the number of steps is lesser. The sixth process portion 214 can involve the repeated determination or estimation of a current cooking vessel temperature in a manner that is identical or analogous to that described above.

A seventh process portion 214 involves detecting or monitoring a current seafood product backbone temperature. The seventh process portion 214 can involve the sensing module's sampling or acquisition of at least one temperature signal from a temperature sensing device such as a thermocouple inserted into or proximate to the seafood product's backbone, and the transfer of a current backbone temperature indicator to the processing module 130.

An eighth process portion 216 involves determining whether the current seafood product backbone temperature equals or approximately equals the cooking phase backbone set point temperature (e.g., approximately 62° C.). If not, the cooking phase can be defined to be in progress or incomplete, in which case the process 200 returns to the sixth and seventh process portions 212, 216 and the cooking phase continues. Once the current seafood product backbone temperature has reached or approximately reached the cooking phase backbone set point temperature, the cooking phase can be defined to be complete and the cooling phase can begin.

Upon completion of the cooking phase, a ninth process portion 218 involves terminating the flow of heated cooking vapour into the cooking vessel 110. A tenth process portion 220 involves providing or delivering cooling fluid into the cooking vessel 110. In various embodiments, cooling fluid is directed into portions of the cooking vessel 110 by way of one or more cooling fluid spray elements such as nozzles configured to spray water.

An eleventh process portion 222 involves sensing or monitoring the current seafood product backbone temperature, and a twelfth process portion 224 involves determining whether the current seafood product backbone temperature has reached or approximately reached the cooling phase backbone set point temperature (e.g., approximately 50° C.). If the current seafood product backbone temperature has not reached or approximately reached the cooling phase backbone set point temperature, the process returns to the tenth process portion 220.

Once the cooling phase backbone set point temperature has been reached, a thirteenth process portion 226 involves cessation of the flow of cooling fluid into the cooking vessel 110, and cessation of the application of the negative pressure to the cooking vessel 110. A fourteenth process portion 228 involves removal or drainage of cooling fluid from the cooking vessel 110, and a fifteenth process portion 230 involves removal of the seafood product from the cooking vessel 110.

In various embodiments, in the seventh process portion 214 and the eleventh process portion 222, involving the sensing of the seafood product backbone temperature, the temperature is not sensed from the backbone of all the seafood products in the cooking vessel. In several embodiments, the backbone temperature is only sensed on a sample of the seafood products. The temperature measured from the sample is then subjected to mathematical processing such as averaging and the resulting value is then taken as a representative temperature for the particular process portion. The sampling is usually performed in a region of the cooking vessel that is lower in temperature than the other regions of the cooking vessel. If the product in the region of the cooking vessel that is lower in temperature is cooked, then the products in the other regions of the cooking vessel (regions excluding the region that is lower in temperature) will be cooked as well. This facilitates optimum and/or reliable cooking of the seafood products in the cooking vessel.

In general, the heat distribution in the cooking vessel is dependent at least on the following factors—the pattern of vapour distribution inside the cooking vessel and the positioning of the seafood products inside the cooking vessel. For example, if the vapour is pumped from a first end of the cooking vessel, a portion of the cooking vessel proximate a second end of the cooking vessel can be lower in temperature than other regions of the cooking vessel, the second end being opposite the first end. As a further example, if the vapour is pumped from the first end of the cooking vessel and a region of the cooking vessel which is approximately in between the first end and the second end of the cooking vessel, the region of the cooking vessel proximate the second end can be lower in temperature than other regions of the cooking vessel. With regards to the positioning of seafood products inside the cooking vessel, where the seafood products are arranged non-uniformly inside the cooking vessel, the region of the cooking vessel downstream from a region densely packed with seafood products can have lesser heat distributed by the vapour, resulting in a temperature lower than regions upstream. Here, downstream and upstream are to be understood with reference to the direction of flow of the vapour.

In various embodiments, the cooking phase backbone set point temperature is in the range of 100° C. to 105° C. and the cooling phase backbone set point temperature is in the range of 62° C. to 75° C. Whenever the cooking process parameters are set, a particular temperature in the above range is selected and set.

A process of cooking a seafood product is described below. Firstly, the process includes providing a cooking vessel comprising a seafood product. The seafood product can be any type of aquatic animal such as a fish. Among fishes, the process can be applied to tuna and other types of fish as well. A negative pressure is then created inside the cooking vessel. The temperature of the cooking vessel is then increased to a first temperature. Vapour comprising water vapour is then pumped into the cooking vessel to initiate a process of attaining a second temperature in the seafood product, wherein the second temperature lesser than the first temperature. The process of attaining the second temperature includes dwelling the cooking vessel at a plurality of intermediate temperatures between the first temperature and the second temperature. The above steps are followed by spraying fluid comprising water on the product inside the cooking vessel to attain a third temperature in the seafood product, the third temperature lesser than the second temperature.

The first temperature is approximately 100° C. In various embodiments, the first temperature is approximately in the range of 100° C. to 105° C. The second temperature is approximately 62° C. In various embodiments, the second temperature is approximately in the range of 62° C. to 75° C. In various embodiments, the third temperature is approximately 50° C. In various embodiments, the plurality of intermediate temperatures includes a range of 2 to 8 intermediate temperatures. In some embodiments, the intermediate temperatures include 8 in number. In various embodiments, the negative pressure has a magnitude of approximately 0.85 bar. In various embodiments, the second temperature and the third temperature are measured at a backbone of the seafood product. In various embodiments, the vapour is steam.

The various embodiments of the system described herein can be configured to operate in accordance with one or more of the processes described above.

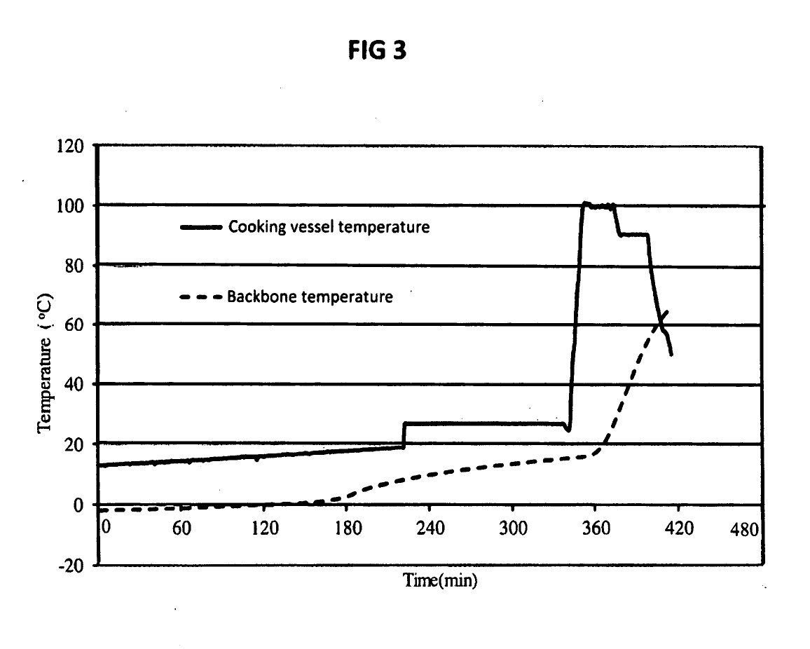

FIG. 3 is a graph showing the relationship between the cooking vessel temperature and the backbone temperature. As is evident from the graph, the cooking vessel temperature is gradually raised to approximately 100° C. and maintained at that temperature for a specified period of time. In other words, it is apparent that once the cooking vessel reaches approximately 100° C., the heating of the cooking vessel is stopped thereby preventing the temperature to increase further. During the cooking phase, the cooking vessel temperature is reduced to approximately 90° C. and maintained at the same temperature for approximately 25 minutes. This is an example of a step mentioned earlier. It is evident from the graph that once the cooking vessel reaches 100° C., there is a steady increase in the backbone temperature of the seafood product, resulting in the cooking of the seafood product.

Particular embodiments of the disclosure are described above for addressing at least one of the previously indicated problems. While features, functions, advantages, and alternatives associated with certain embodiments have been described within the context of those embodiments, other embodiments may also exhibit such advantages, and not all embodiments need necessarily exhibit such advantages to fall within the scope of the disclosure. It will be appreciated that several of the above-disclosed structures, features and functions, or alternatives thereof, may be desirably combined into other different devices, systems, or applications. The above-disclosed structures, features and functions, or alternatives thereof, as well as various presently unforeseen or unanticipated alternatives, modifications, variations or improvements thereto that may be subsequently made by one of ordinary skill in the art, are encompassed by the following claims.

1. A system for cooking a seafood product, comprising:
a cooking vessel configured to carry the seafood product, the cooking vessel configurable to receive a set of control signals;
a sensing module couplable to the cooking vessel and configurable to measure a set of physical parameters of the cooking vessel and output a set of signals corresponding to the set of physical parameters;
a processing module couplable to the sensing module, the processing module configurable to execute a set of stored program instructions and process at least one signal received from the sensing module;
a control module couplable to the processing module and the cooking vessel, the control module configurable to receive control commands from the processing module and output the set of control signals to the cooking vessel; and
a memory module couplable to the processing module, the memory module configurable to store a cooking control manager comprising a set of program instructions—to perform a cooking method comprising:
(a) loading the product inside the cooking vessel of the system;
(b) creating a negative pressure inside the cooking vessel;
(c) increasing the temperature of the cooking vessel to a first temperature;
(d) pumping in vapour comprising water vapour into the cooking vessel to initiate a process of attaining a second temperature in the seafood product, the second temperature lesser than the first temperature and wherein the process of attaining the second temperature comprises dwelling the cooking vessel at a plurality of intermediate temperatures between the first temperature and the second temperature; and
(e) spraying fluid comprising water on the product inside the cooking vessel to attain a third temperature in the seafood product, the third temperature lesser than the second temperature.

2. The system as claimed in claim 1, wherein the first temperature is approximately in the range of 100° C. to 105° C.

3. The system as claimed in claim 2, wherein the first temperature is approximately 100° C.

4. The system as claimed in claim 1, wherein the second temperature is approximately in the range of 62° C. to 75° C.

5. The system as claimed in claim 4, wherein the second temperature is approximately 62° C.

6. The system as claimed in claim 1, wherein the third temperature is approximately 50° C.

7. The system as claimed in claim 1, wherein the plurality of intermediate temperatures comprises 8 temperatures.

8. The system as claimed in claim 1, wherein the negative pressure has a magnitude of approximately 0.85 bar.

9. The system as claimed in claim 1, wherein the second temperature and the third temperature are measured at a backbone of the seafood product.

10. The system as claimed in claim 1, wherein vapour is steam.

11. A method of cooking a seafood product, comprising:
(a) providing a cooking vessel comprising a seafood product;
(b) creating a negative pressure inside the cooking vessel;
(c) increasing the temperature of the cooking vessel to a first temperature;
(d) pumping in vapour comprising water vapour into the cooking vessel to initiate a process of attaining a second temperature in the seafood product, the second temperature lesser than the first temperature and wherein the process of attaining the second temperature comprises dwelling the cooking vessel at a plurality of intermediate temperatures between the first temperature and the second temperature; and
(e) spraying fluid comprising water on the product inside the cooking vessel to attain a third temperature in the seafood product, the third temperature lesser than the second temperature.

12. The method as claimed in claim 11, wherein the first temperature is approximately in the range of 100° C. to 105° C.

13. The method as claimed in claim 12, wherein the first temperature is approximately 100° C.

14. The method as claimed in claim 11, wherein the second temperature is approximately in the range of 62° C. to 75° C.

15. The method as claimed in claim 14, wherein the second temperature is approximately 62° C.

16. The method as claimed in claim 11, wherein the third temperature is approximately 50° C.

17. The method as claimed in claim 11, wherein the plurality of intermediate temperatures comprises 8 temperatures.

18. The method as claimed in claim 11, wherein the negative pressure has a magnitude of approximately 0.85 bar.

19. The method as claimed in claim 11, wherein the second temperature and the third temperature are measured at a backbone of the seafood product.

20. The method a claimed in claim 11, wherein vapour is steam.
